(19) United States
(12) Patent Application Publication
(10) Pub. No.: US 2009/0181137 A1
(43) Pub. Date: Jul. 16, 2009

(54) Frozen Confections Fortified with Calcium

(76) Inventors: Mark John Berry, Sharnbrook (GB); Patricia Jill Quail, Sharnbrook (GB); Joy Elizabeth Wilkinson, Sharnbrook (GB)

Correspondence Address: UNILEVER PATENT GROUP, 800 SYLVAN AVENUE, AG West S. Wing, ENGLEWOOD CLIFFS, NJ, 07632-3100, US

(21) Appl. No.: 12/227,681

(22) PCT Filed: May 23, 2007
(86) PCT No.: PCT/EP2007/055018

§ 371 Date: Nov. 24, 2008

(30) Foreign Application Priority Data
Jun. 1, 2006 (EP) 06076143.4

(51) Int. Cl. B65D 85/78; A23G 9/32; A23L 3/00

(52) U.S. Cl. 426/130; 426/585; 426/522

(57) ABSTRACT

The present invention provides frozen confections having an overrun of less than 30% and comprising by weight of the frozen confection: at least 0.2% calcium, at most 17% free sugars, and from 0.1 to 20% fat which contains less than 20% saturated fatty acids by weight of the fat; wherein at least 20% by weight of the calcium is present as part of a milk mineral composition.

### FIELD OF THE INVENTION

The present invention relates to food products fortified with calcium, wherein at least 20% by weight of the calcium is present as part of a milk mineral composition. In particular the present invention relates to frozen confections fortified with calcium.

### BACKGROUND TO THE INVENTION

Calcium is required for healthy bones and teeth and therefore it is an important component of the diet. It is especially important for children to get sufficient calcium. Traditional calcium-containing foods, such as milk, cheese and yoghurt, are not appealing to some consumers (especially children) so many people do not consume enough to obtain sufficient calcium. This can be due to a dislike of the taste, or in the case of milk, the inconvenience of needing to drink large volumes, and its image of being “old-fashioned”, “sensible”, or boring.

Thus there have been attempts to provide foods and beverages fortified with calcium but with increased appeal. For example, biscuits, cereal bars, milkshakes and ice creams fortified with calcium are known in the art. However, although such products are appealing to children, they are considered by many consumers to be unsuitable for regular or everyday consumption because of their high content of sugar and/or saturated fat. Thus there remains a need to provide food products that are a good source of calcium, are appealing to children, and are also suitable for everyday consumption in respect of other nutrients.

The advantage of the compositions according to present invention, wherein at least 20% by weight of the calcium is present as part of a milk mineral composition, is that they provide (in addition to calcium) trace elements, phosphates that are also needed for bone health, and balanced amounts of other essential minerals such as magnesium.

### DEFINITIONS

Definitions and descriptions of various terms and techniques used in frozen confectionery manufacture are found in Ice Cream, 6^{th} Edition, Robert T. Marshall, H. Douglas Goff and Richard W. Hartel (2003), Kluwer Academic/Plenum Publishers.

All percentages, unless otherwise stated, refer to the percentage by weight, with the exception of percentages cited in relation to the overrun.

### Fat

The term “fat” refers to saturated, mono-unsaturated and poly-unsaturated fatty acids. Fatty acids are usually present in the form of esters (e.g. mono-/di-/tri-glycerides).

### Sweetener

Sweetener means a sugar (i.e. mono and disaccharides), oligosaccharide containing from 3 to ten monosaccharide units joined in glycosidic linkage, glucose syrup with a dextrose equivalent (DE) of greater than 20, sugar alcohol, or a mixture thereof. Sweeteners include sucrose, fructose, lactose (for example from the source of milk protein), dextrose, invert sugar, corn syrup and sorbitol.

### Free Sugars

As used herein, the term “free sugars” is defined as in “Diet, nutrition and the prevention of chronic diseases”—Report of a Joint WHO/FAO Expert Consultation, WHO Technical Report Series 916, WHO, Geneva, 2003. Thus free sugars are all mono and disaccharides added by the manufacturer, cook or consumer plus sugar naturally present and sourced from honey, syrups and juices. Free sugars do not include sugars naturally present and sourced from fruit or milk.

### Overrun

Overrun is defined by the following equation:

$$overrun ( \% ) = \frac{density of premix - density of frozen confection}{d ensity of frozen confection} \times 100.$$

“Premix” refers to the unaerated mix prior to aeration or following de-aeration of the melted frozen confection. Overrun is measured at atmospheric pressure.

### Milk Mineral Composition

By “milk mineral composition” is meant a mixture of minerals substantially in the proportions found in bovine milk. Thus the milk mineral composition may be sourced from liquid milk, concentrated milk, milk powders, whey, whey powders and/or whey protein concentrates/isolates. Isolated milk mineral compositions may be prepared from filtration of milk and milk derivatives, e.g. by the process described in European patent application EP 1 031 288 A1. Such isolated compositions are available commercially. For example DMV International (Veghel, The Netherlands) supplies a milk mineral composition under the trade name Lactoval™, and ARLA Foods Ingredients (Skanderborgvej, Denmark) under the trade name CAPOLAC™.

### SUMMARY OF THE INVENTION

We have found that calcium fortified frozen confections can be formulated that are not only appealing to consumers, especially children, but also suitable for everyday consumption. Accordingly in a first aspect the present invention provides a frozen confection having an overrun of less than 30% and comprising (by weight of the frozen confection):
at least 0.2% calcium,
at most 17% free sugars, and
from 0.1 to 20% fat which contains less than 20% saturated fatty acids by weight of the fat,
wherein at least 20% by weight of the calcium is present as part of a milk mineral composition.

Unaerated/low overrun frozen confections, such as milk ices, have a particular appeal for some children, especially young children, since (compared to aerated confections such as ice cream) they are longer-lasting, can be sucked, are less likely to fall off a stick and are smaller in volume for the same mass and are therefore easier for small hands to hold. By fortifying such confections with calcium and simultaneously formulating them to contain low amounts of saturated fat and free sugar, they can be made suitable for everyday consumption.

Conventional frozen confections, such as milk ices, have a calcium level of less than about 0.15%, typically about 0.1 wt %, whereas the level of calcium in the frozen confection of the present invention is at least 0.2% by weight of the frozen confection. Preferably the level of calcium is at least 0.3%, and levels of calcium of at least 0.4% or at least 0.5% are contemplated.

The frozen confections according to the present invention comprise calcium wherein at least 20% by weight of the calcium is present as part of a milk mineral composition Preferably the frozen confections according to the present invention comprise calcium wherein at least 50% by weight of the calcium is present as part of a milk mineral composition.

More preferably the frozen confections according to the present invention comprise calcium wherein at least 75% by weight of the calcium is present as part of a milk mineral composition

Preferably the total amount of fat is less than 15% by weight of the frozen confection, more preferably less than 10% or 5%, most preferably less than 3%, in order to prevent the frozen confection from having too high an energy density (i.e. calorie content).

Preferably the amount of total fat is at least 0.5% by weight of the frozen confection, more preferably at least 1%. Frozen confections containing at least a small amount of fat are perceived as ice cream or milk ice type products and are more attractive to many consumers than completely fat-free frozen confections.

The frozen confection comprises minimal amounts of saturated fat, i.e. the fat comprises less than 20% saturated fatty acids, preferably less than 18%, more preferably less than 16% saturated fatty acids by weight of the fat. Foods suitable for everyday consumption should not contain high levels of saturated fat.

Preferably the fat comprises at least 80% by weight of the fat of a vegetable oil selected from the group consisting of olive oil, sunflower oil, safflower oil, rapeseed oil, corn oil, peanut oil, linseed oil, soybean oil, walnut oil, grapeseed oil, sesame oil, wheat germ oil, cottonseed oil and mixtures thereof.

In order to maximise the suitability of frozen confection for daily consumption, it is preferable that the fat comprises at least 35% polyunsaturated fatty acids by weight of the fat, more preferably at least 40% and optimally at least 50%.

In a particularly preferred embodiment the fat is sunflower oil owing to its clean flavour, high polyunsaturated fat content and wide availability.

Preferably the frozen confection comprises at least 1% milk protein by weight of the frozen confection.

Preferably the amount of free sugars is less than 16% by weight of the frozen confection, more preferably less than 15%. Foods suitable for everyday consumption should not contain high levels of free sugars.

Preferably the frozen confection has an overrun of less than 20%, more preferably less than 10%.

Preferably the frozen confection comprises at least 2% oligofructose by weight of the frozen confection.

Preferably the frozen confection is fortified with vitamin D.

Preferably the frozen confection is provided in a portion of from 20 to 100 g. In a related aspect, the present invention provides a pack containing from 2 to 10 such portions of frozen confection.

In another aspect the present invention provides a process for preparing a frozen confection according to the first aspect of the invention, the process comprising the steps of:
a) preparing a premix comprising fat and water;
b) pasteurising/sterilising and/or homogenising the premix;
c) freezing the premix.

Preferably the freezing step is quiescent.

### DETAILED DESCRIPTION OF THE INVENTION

Frozen confections are sweet-tasting fabricated foodstuffs intended for consumption in the frozen state (i.e. under conditions wherein the temperature of the confection is less than 0° C., and preferably under conditions wherein the confection comprises significant amounts of ice). The frozen confections of the present invention comprise a dispersion of fat in an aqueous medium and are unaerated or have low overrun. Typical examples of such frozen confections include milk ices. Low overrun frozen confections may be deliberately aerated, but have overrun of 30% or less. An unaerated ice confection is not subjected to deliberate steps such as whipping to increase the gas content. Nonetheless, it will be appreciated that during the preparation of unaerated frozen confections, low levels of gas, such as air, may be incorporated in the product. Frozen confections are typically provided as stick products, but may also be in other formats, for example as bars, in tubes, in tubs, or as a plurality of discrete small pieces.

Suitable sources for the fat include vegetable oils with low levels of saturated fat and/or high levels of polyunsaturated fat. Preferably the fat is provided in the form of refined vegetable oil, since refined vegetable oils provide a convenient and easy to handle source of fat.

Preferably the fat comprises at least 80%, more preferably at least 90%, and even more preferably at least 95% by weight of the fat of a vegetable oil. Suitable vegetable oils include olive oil, sunflower oil, safflower oil, rapeseed oil (canola oil), corn oil, peanut oil, linseed oil, soybean oil, walnut oil, grapeseed oil, sesame oil, wheat germ oil, cottonseed oil and mixtures thereof. More preferably the fat is selected from the group consisting of sunflower oil, olive oil, rapeseed oil or mixtures thereof. Most preferably the fat is sunflower oil.

In order to provide the customary sweetness associated with frozen confections and to avoid the confection being unduly hard, it is preferable that confections comprise sweeteners in an amount of at least 10% by weight of the confection, more preferably at least 15%, most preferably at least 17%. To avoid the confection being too sweet, the amount of sweeteners should be at most 35%, preferably at most 30%, more preferably at most 25% by weight of the confection.

A preferred sweetener is lactose, because lactose may aid calcium absorption and has a low relative sweetness. Lactose is particularly preferred when added as part of the milk solids because it is then not counted among the unhealthy free sugars. Thus it is preferable that lactose is present in an amount of at least 2% by weight of the frozen confection, preferably at least 3%, more preferably at least 4%. In order to avoid crystallisation of the lactose, however, it is also preferred that the lactose is present in an amount of less than 9%, preferably less than 8% by weight of the frozen confection.

It is preferable that the frozen confection comprises protein in an amount of at least 1% by weight of the frozen confection, more preferably at least 2%. Frozen confections containing at least this amount of protein are perceived as ice cream or milk ice type products and are more attractive to many consumers than substantially protein-free frozen confections (such as water ices). In order to prevent the frozen confection from exhibiting a chalky mouth-feel, however, it is also preferable that the protein content is less than 8%, more preferably less than 6% by weight of the frozen confection. Suitable proteins for use in the present invention include proteins such as milk proteins, egg proteins and gelatin as well as vegetable proteins such as soya proteins. Particularly preferred are milk proteins owing to their superior flavour, heat stability and surface activity.

Suitable sources of milk protein include milk, concentrated milk, milk powders, whey, whey powders and whey protein concentrates/isolates. Most preferred are caseins owing to their ability to bind calcium and because they are digested to casein phosphopeptides (CPPs) by proteases in the gut. Suitable additional sources of casein include caseinates such as sodium and/or calcium caseinates. Sources of milk protein generally also comprise other materials. For example, skimmed milk powder typically comprises lactose, milk protein and milk minerals.

The frozen confections of the present invention comprise at least 40% water by weight of the frozen confection, preferably at least 50% and more preferably at least 60%. Such amounts of water are important to ensure that the frozen confection contains optimum amounts of ice in the frozen state.

Additional components may be included in the frozen confection to optimise bio-availability of the calcium. In particular chelating agents which increase the solubility and/or dispersibility of calcium may be included. Such chelating agents include casein phosphopeptides (CPPs) and hydrolysed polysaccharides or mixtures thereof. Suitable hydrolysed polysaccharides are described in European patent application EP 0 889 696 A. Casein phosphopeptides are the preferred chelating agents of this invention owing to their ability to increase the solubility of calcium. It is believed that, in order to be absorbed in the small intestine, the calcium must be soluble. CPPs are available commercially, for example from DMV International under the trade name CE90CPP™. Preferred amounts of chelating agent are at least 0.5 mg, more preferably at least 2 mg, most preferably at least 3 mg per mg of calcium.

Another agent which increases the absorption of calcium is oligofructose. Oligofructose also provides sweetness without contributing to the free sugars. Preferably the frozen confection comprises at least 2%, more preferably at least 3% oligofructose by weight of the frozen confection.

Yet another agent which increases the absorption of calcium is vitamin D. Preferably the frozen confection comprises at least 3 μg of vitamin D and/or derivatives thereof per 100 g of the frozen confection, more preferably at least 5 μg and most preferably at least 7 μg. Preferably also, in order to avoid unwanted physiological effects, the amount of vitamin D and/or derivatives thereof is less than 65 μg per 100 g of the frozen confection. (Quantities of vitamin D are sometimes expressed in units of IU: 1 μg of vitamin D₃ is equivalent to 40 IU). Of the group of steroid molecules that are known as vitamin D, the preferred forms are vitamin D₃ (cholecalciferol) and/or derivatives thereof, vitamin D₂ (ergocalciferol) and/or derivatives thereof, and mixtures thereof. Particularly preferred is vitamin D₃ as it is the natural form of vitamin D.

The frozen confections may also comprise a stabiliser. Suitable stabilisers include one or more of alginates, gum arabic, gum ghatti, gum karaya, gum tragacanth, locust bean gum, carrageenans, xanthan gum, guar gum, gelatine, agar, sodium carboxymethylcellulose, microcrystalline cellulose, methyl and methylethyl celluloses, hydroxypropyl and hydroxypropylmethyl celluloses, low and high methoxyl pectins, starches, maltodextrins, modified starches, and mixtures thereof.

The frozen confections may also comprise an emulsifier. Suitable emulsifiers include one or more of mono- and di-glycerides of saturated or unsaturated fatty acids (e.g. monoglyceryl palmitate—MGP), polyoxyethylene derivatives of hexahydric alcohols (usually sorbitol), glycols, glycol esters, polyglycerol esters, sorbitan esters, stearoyl lactylate, acetic acid esters, lactic acid esters, citric acid esters, acetylated monoglyceride, diacetyl tartaric acid esters, polyoxyethylene sorbitan esters (such as polysorbate 80), sucrose esters, lecithin, egg yolk. However, in a preferred embodiment the frozen confection is substantially free from emulsifier. In particular, the frozen confection may comprise less than 0.04%, more preferably less than 0.02%, even more preferably less than 0.01% total emulsifier by weight of the frozen confection.

Preferably the frozen confection does not comprise coatings or inclusions of chocolate, couverture, toffee, fudge or caramel or the like since these typically contain high amounts of sugar and/or fat and therefore make the frozen confection less suitable for everyday consumption.

The frozen confections of the present invention may be conveniently provided in single serve portions of from 20 g to 100 g, preferably from 20 to 75 g, more preferably from 25 to 75 g. Portions of this size are suitable for consumption once per day and provide a significant proportion of the recommended daily amount of calcium. In a particularly preferred embodiment, a single serving (e.g. 60 g) of the frozen confection contains at least as much calcium as a glass (e.g. 200 ml) of whole bovine milk.

The present invention also provides a pack containing a plurality of such portions, for example from 2 to 10 portions. Packs containing a plurality of such portions are a convenient way of providing several days' supply of portions which are suitable for consumption once per day.

The frozen confections may be manufactured by any suitable process. However, it is preferred that the frozen confection is manufactured by a process comprising the steps of:
a) preparing a premix comprising fat and water;
b) pasteurising/sterilising and/or homogenising the premix;
c) freezing the premix

The premix comprises all the ingredients of the frozen confection.

The premix, which is used for producing the frozen confection according to the present invention, comprises

at least 0.2% calcium, wherein at least 20% by weight of the calcium is present as part of a milk mineral composition,
at most 17% of free sugars,
from 0.1 to 20% fat which contains less than 20% saturated fatty acids by weight of the fat,
water and
optionally additional ingredients.

Therefore a further embodiment of the present invention is a process for manufacturing the frozen confection comprising the steps of:
a) preparing a premix, which comprises
   at least 0.2% calcium, wherein at least 20% by weight of the calcium is present as part of a milk mineral composition,
   at most 17% of free sugars,
   from 0.1 to 20% fat which contains less than 20% saturated fatty acids by weight of the fat,
   water and
   optionally additional ingredients;
b) pasteurising/sterilising and/or homogenising the premix;
c) freezing the premix

The freezing step may be performed quiescently or with agitation, such as in a surface-scraped heat exchanger. By quiescent (or static) freezing, it is meant a process wherein the mix is cooled below its freezing point, such that partial or total solidification occurs through ice crystal formation, in the absence of an imposed shear field. Thus the liquid is frozen without it being deliberately agitated, mixed or shaken during freezing. Examples of quiescent processes include (but are not limited to) placing a container containing the mix into a cold environment and immersing a mould containing the mix in a bath of cold refrigerant.

The invention will now be further described by reference to the following non-limiting examples.

### EXAMPLES

Examples 1-3 demonstrate the formulation and manufacture of three frozen confections according to the invention. Example 1 is a milk ice type formulation, and examples 2 and 3 are more typical of ice cream formulations.

### Materials

The frozen confections were formulated using the following materials:
Fructose, sucrose and dextrose monohydrate were pure and crystalline and supplied by Tate and Lyle.
Low fructose corn syrup was C*Sweet F017Y4 which contains 55% mono/disaccharides, a moisture level of 22%, a DE of 63 and was supplied by Cerestar.
Oligofructose was Raftilose™ P95 supplied by ORAFTI (Tienen, Belgium) and had a moisture content of 3% (w/w). On a dry basis the Raftilose™ consisted of 95% (w/w) oligofructose and 5% (w/w) sugars (consisting of 3% sucrose, 1% fructose and 1% glucose).
   Skimmed milk powder (SMP) was supplied by Dairy Crest Ingredients and contained 52% (w/w) lactose, 36% protein, 1.25% maximum of milk fat, 1.15% calcium and 6.7% other milk minerals, with the remainder being moisture.
   Whey powder was Avonol 600 supplied by Glanbia Ingredients and contained 55% (w/w) lactose, 31% protein, 2% milk fat, 0.69% calcium and 7.3% other milk minerals with the remainder being moisture.
   Sunflower oil was supplied by Leon Frenkel Ltd and had a saturated fatty acid content of around 12% and a polyunsaturated fat content of around 63%.
   Locust Bean Gum (LBG) was Grindsted LBG 246 supplied by Danisco.
   Carrageenan was Lactarin MV3255 supplied by FMC BioPolymer.
   Guar gum was supplied by Willy Benecke.
   Milk mineral composition was CAPOLAC® MM-0525 BG supplied by Arla Foods Ingredients and had a calcium content of 24% by weight of the milk mineral composition.
   Vitamin D preparation was Dry Vitamin D3 100 CWS/AM supplied by DSM Nutritional Products Europe and contained 90,000-110,000 IU of vitamin D₃ per g of the preparation (40 IU equivalent to 1 μg)

### Formulations

The formulations are given in Table 1.

TABLE 1

| Ingredient (weight %) | 1 | 2 | 3 |
|---|---|---|---|
| Sucrose | 11.0 | 5.0 | 11.0 |
| Low fructose corn syrup | 7.0 | — | 10.5 |
| Dextrose monohydrate | — | 5.8 | — |
| Fructose | — | 4.4 | — |
| Oligofructose | — | 4.0 | — |
| Skimmed milk powder | 6.0 | 5.0 | 5.0 |
| Whey powder | 5.0 | 5.0 | 5.0 |
| Milk mineral composition | 1.3 | 1.7 | 1.7 |
| Sunflower oil | 2.5 | 8.0 | 8.0 |
| Locust Bean Gum | 0.225 | 0.25 | 0.25 |
| Carrageenan | 0.03 | 0.04 | 0.04 |
| Guar gum | 0.075 | 0.11 | 0.11 |
| Vanilla flavour | 0.012 | 0.18 | 0.18 |
| Vitamin D preparation* | 0, 0.00074, 0.0148 | — | 0.005 |
| Water | to 100 | to 100 | to 100 |

*Example 1 was prepared in three variants, containing different amounts of vitamin D, corresponding to 0, 1 μg, 20 μg per 60 g portion. Example 3 corresponds to 7 μg of vitamin D per 60 g portion.

### Process

Mixes were prepared as follows. Water at 80° C. was added into a tank equipped with a turbo mixer. The dry sugars were mixed with the stabilisers and added to the tank followed by the skimmed milk powder, liquid sugars, oil and flavours. The mix was blended for about 10 minutes at 60-70° C. The mix was then homogenised at 150 bar and pasteurised at 82° C. for 25 seconds in a plate heat exchanger. The mix was then cooled to 4° C. in the plate heat exchanger and stored at 4° C. until use.

Unaerated stick products were prepared by pouring the mixes into stainless steel moulds. The moulds were placed in a glycol bath at −25° C. until the mix was frozen. Wooden sticks were inserted once the product had started to freeze. After freezing, the moulds were immersed in warm water (25° C.-30° C.) to release the frozen products from the moulds. The products (weighing approximately 60 g each) were put in packets and stored in a freezer at −25° C.

### Products

The frozen confections of example 1 contain 250 mg of calcium per 60 g portion (0.42%), 14.7% free sugars, and 2.5% fat, of which about 0.3% is saturated, 0.7% is monounsaturated and 1.5% is polyunsaturated. The products were tasted informally and found to be of a good flavour and texture, comparable to conventional milk ice products. No differences were noted between the products with different levels of vitamin D.

The frozen confections of example 2 contain 300 mg of calcium per 60 g portion (0.50%), 14.9% free sugars and 8.0% fat, of which about 1% is saturated, 2% is monounsaturated and 5% is polyunsaturated. The frozen confections of example 3 contain 300 mg of calcium per 60 g portion (0.50%), 16.8% free sugars and 8.0% fat, of which about 1% is saturated, 2% is monounsaturated and 5% is polyunsaturated. The both products were tasted informally and found to be of a good flavour and texture, comparable to conventional unaerated ice cream products.

The various features and embodiments of the present invention, referred to in individual sections above apply, as appropriate, to other sections, mutatis mutandis. Consequently features specified in one section may be combined with features specified in other sections, as appropriate.

All publications mentioned in the above specification are herein incorporated by reference. Various modifications and variations of the described methods and products of the invention will be apparent to those skilled in the art without departing from the scope of the invention. Although the invention has been described in connection with specific preferred embodiments, it should be understood that the invention as claimed should not be unduly limited to such specific embodiments. Indeed, various modifications of the described modes for carrying out the invention which are apparent to those skilled in the relevant fields are intended to be within the scope of the following claims.

1. A frozen confection having an overrun of less than 30% and comprising by weight of the frozen confection:
at least 0.2% calcium,
at most 17% free sugars, and
from 0.1 to 20% fat which contains less than 20% saturated fatty acids by weight of the fat,
wherein at least 50% by weight of the calcium is present as part of a milk mineral composition.

2. A frozen confection according to claim 1 wherein at least 75% by weight of the calcium is present as part of a milk mineral composition.

3. A frozen confection according to claim 1 comprising from 0.5 to 10% fat by weight of the frozen confection.

4. A frozen confection according to claim 1 comprising from 1.0 to 5.0% fat by weight of the frozen confection.

5. A frozen confection according to claim 1 wherein the fat comprises at least 80% by weight of the fat of a vegetable oil selected from the group consisting of olive oil, sunflower oil, safflower oil, rapeseed oil, corn oil, peanut oil, linseed oil, soybean oil, walnut oil, grapeseed oil, sesame oil, wheat germ oil, cottonseed oil and mixtures thereof.

6. A frozen confection according to claim 1 wherein the fat comprises at least 35% polyunsaturated fatty acids by weight of the fat.

7. A frozen confection according to claim 6 wherein the fat is sunflower oil.

8. A frozen confection according to claim 1 comprising at least 1% milk protein by weight of the frozen confection.

9. A frozen confection according to claim 1 comprising less than 15% free sugars by weight of the frozen confection.

10. A frozen confection according to claim 1 wherein the overrun is less than 20%.

11. A frozen confection according to claim 1 wherein the frozen confection comprises at least 2% oligofructose by weight of the frozen confection.

12. A frozen confection according to claim 1 wherein the frozen confection is fortified with vitamin D.

13. A frozen confection according to claim 1 in a portion of from 20 to 100 g.

14. A pack containing from 2 to 10 portions of frozen confection according to claim 13.

15. A process for preparing a frozen confection according to claim 1, the process comprising the steps of:
a) preparing a premix comprising fat and water;
b) pasteurising/sterilising and/or homogenising the premix;
c) freezing the premix.

16. A process according to claim 15, wherein the premix comprises
at least 0.2% calcium, wherein at least 50% by weight of the calcium is present as part of a milk mineral composition,
at most 17% of free sugars,
from 0.1 to 20% fat which contains less than 20% saturated fatty acids by weight of the fat,
water and
optionally additional ingredients.

17. A process according to claim 1 wherein the freezing step is quiescent.
